(19) United States
(12) Patent Application Publication
(10) Pub. No.: US 2023/0146090 A1
(43) Pub. Date: May 11, 2023

(54) SYSTEM FOR MONITORING A VEHICLE TRANSPORTED CARGO

(71) Applicant: ALBERTO DAVID ESCOBAR, CALI (CO)

(72) Inventor: ALBERTO DAVID ESCOBAR, CALI (CO)

(73) Assignee: NAVISAF S.A.S, Cali (CO)

(21) Appl. No.: 17/519,631

(22) Filed: Nov. 5, 2021

(51) Int. Cl. H04M 1/72409; H04W 4/48; H04L 29/08

(52) U.S. Cl. CPC H04M 1/72409; H04W 4/48; H04L 67/12

(57) ABSTRACT

The present invention provides a system for monitoring a vehicle transported cargo shipment, the vehicle and its operator to address or prevent potential mishaps and loss of the cargo, wherein the system uses the smart phone of the operator of the vehicle and an application in the smart phone, wherein the application is activated by a first wireless communicating device placed in the vehicle and wherein the first communicating device is wirelessly and constantly linked to a second wireless communicating device attached to the cargo as long as the cargo is in the vehicle, wherein the application in the smart phone generates dynamic data about the vehicle and about the constant virtual link between the first and second communicating devices; and wherein the application sends the dynamic data to at least one computer server by means of the internet of things.

### BACKGROUND OF THE INVENTION

### 1. Field of the Invention

The present invention is related to a system for monitoring cargo being transported in a vehicle, wherein the system by means of a computer server receives dynamic data from the smart phone of the operator of the vehicle transporting the cargo by means of an application in the smart phone, wherein the smart phone application is dynamically activated wirelessly by a first device attached to the vehicle transporting the cargo and a virtual link between the first device in the vehicle and a second device attached to the cargo, wherein the data from the vehicle and the virtual link is relayed to the computer server by the application in the smart phone of the operator of the vehicle transporting the cargo by means of the internet of things.

### 2. Description of Prior Art

To address the perennial need to reduce mishaps and loss of cargo shipments transported in vehicles, there are many described methods and systems based on devices that scan labels or identifiers in the shipments and on global position system (GPS) devices attached to the vehicles transporting the shipments. However, there is no description of a system providing a link among the operator of the vehicle transporting a shipment, the shipment, and the vehicle, wherein a rupture of the link may indicate a potential mishap or loss of the shipment.

The present invention provides a system that monitors the driver of a vehicle transporting a cargo, the vehicle and the cargo by means of an application in the smartphone of the operator, wherein the application is activated wirelessly by a first device attached to the vehicle transporting the cargo, wherein this first device is linked wirelessly to a second device attached to the cargo.

### SUMMARY OF THE INVENTION

The present invention provides a system for monitoring a vehicle transported cargo shipment, the vehicle and its operator to address or prevent potential mishaps and loss of the cargo, wherein the system uses the smart phone of the operator of the vehicle and an application in the smart phone, wherein the application is activated by a first wireless communicating device placed in the vehicle and wherein the first communicating device is wirelessly and constantly linked to a second wireless communicating device attached to the cargo as long as the cargo is in the vehicle, wherein the application in the smart phone generates dynamic data about the vehicle and about the constant virtual link between the first and second communicating devices; and wherein the application sends the dynamic data to at least one computer server by means of the internet of things.

Specifically, the present invention provides A system for monitoring a vehicle transported cargo shipment comprising:
a. a first wireless communicating device placed in the vehicle;
b. a second wireless communicating device attached to the cargo, wherein the second device communicates wirelessly with the first communicating device; wherein the first and second communicating devices communicate permanently creating an constant virtual link as long as the cargo is being carried in the vehicle;
c. a smart phone with an application, wherein the first device wirelessly communicates with the smart phone, wherein the first device activates the application in the smart phone, wherein the activated application in the smartphone generates dynamic data about the vehicle and about the constant virtual link between the first and second communicating devices; wherein the vehicle transports the cargo with the attached second communicating device;
d. at least one computer server, wherein the smart phone sends the dynamic data about the vehicle and about the constant virtual link, by means of the internet of things, to the computer server;

wherein the computer server is programmed to use the received dynamic data to register the dynamic variables of vehicle, the presence of the vehicle operator close to or in the vehicle, and the presence of the cargo in the vehicle;

wherein the computer server generates alarm warnings when the operator of the vehicle is away from the vehicle and the cargo is no longer in the vehicle, or when the operator of the vehicle is away from the vehicle, or when the cargo is no longer in the vehicle.

Objectives and advantages of the present Application invention will be more evident in the detailed description of the invention and the claims.

### BRIEF DESCRIPTION OF THE DRAWINGS

FIG. 1. is an illustration of an embodiment of the system of the present invention that shows a wireless communication, indicated by means of a dotted line (7), between a first device (1) attached to a vehicle, and the vehicle's operator (4) smart phone (2); FIG. 1. also illustrates the wireless communication link, indicated by dotted line (6), between the first device (1) and a second device (3), wherein the second device (3) is attached to the cargo (5) in the vehicle, and wherein the smart phone (2) communicates and sends data, indicated by dotted lines (8), by means of a cell tower (9) to a computer server (10).

### DETAILED DESCRIPTION OF THE INVENTION

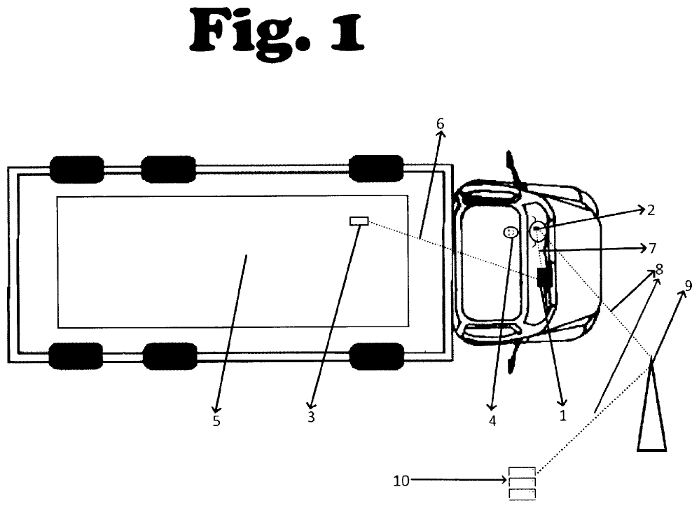

FIG. 1 shows an illustration of an embodiment of a system for monitoring a vehicle transported cargo comprising:
a. a first wireless communicating device (1) placed in the vehicle transporting the cargo (5);
b. a smart phone (2) with an application, wherein the smartphone (2) is with the vehicle's operator (4), wherein the first device communicates (1) wirelessly with the smart phone (2) of the operator (4) of the vehicle, wherein the first device (1) activates an application in the smart phone (2), wherein the activated application in the smartphone (2) generates dynamic data about the vehicle
c. at least one computer server (10), wherein the smart phone (2) sends the dynamic data (8) about the vehicle, by means of the internet of things (9), to the computer server (10).

In a further aspect of the system of the present invention at least a second wireless communicating device (3) attached to the cargo (5), wherein the vehicle transports the cargo (5) with the attached second communicating device (3); wherein the second device (3) communicates wirelessly with the first communicating device (1); wherein the first (1) and second (3) communicating devices communicate permanently creating an constant virtual link (6) as long as the cargo (5) is being carried in the vehicle; wherein the first device (1) communicates wirelessly (7) with the smart phone (2) of the operator (4) of the vehicle activating the application in the smart phone (2), wherein the activated application in the smart phone (2) generates dynamic data about the vehicle and about the constant virtual link (6) between the first (1) and second (3) communicating devices; wherein the smart phone (3) sends (8) the dynamic data about the vehicle and about the constant virtual link (6), by means of the internet of things (9), to the computer server (10).

For the purpose of the present invention a server refers to a computer server.

In one aspect of the inspection system of the present invention, the server (10) receives data from the application in the smart phone (2) of the operator (4) of the vehicle by means of the Internet of Things (IoT), wherein the IoT for the purpose of the present invention is defined as an arrangement of sensors, geographical beacons, communicating mobile phone towers (9), satellites, computing devices, computer servers, communicating devices, mechanical and digital machines, objects, animals, people etc., that are provided with unique identifiers (UIDs) and the ability to transfer data from one component of the arrangement to another component of the arrangement, and over a network or networks.

For the purpose of the present invention a smart phone is a cell mobile communicating device that connects to the IoT and can relay information to computer server. The smart phone (2) of the present invention will be equipped with features now common in current smart phones, wherein the features comprise but are not limited to a GPS sensor, a gyroscope, an accelerometer, a barometer, a magnetometer, ambient light sensor, proximity sensor, time clock, Bluetooth, wifi, etc.

The application installed in the vehicle operator's smartphone (2), for the purpose of the present invention, is an application that is only activated when actively communicating with the first device (1), wherein the activation of the application happens by means of the Bluetooth smart phone (2) feature, and a Bluetooth feature built in the first device (1), wherein the first device (1) has a built in battery to self-power, wherein the first device (1) is in a hidden location in the vehicle, wherein the hidden location is not known to the vehicle's operator, wherein the first device has a built in transmitter and receiving wireless feature, wherein the first device (1) is constantly communicating with the second device (3) and the vehicle's operator smart phone (2), wherein the first device (1) is constantly broadcasting an encrypted key or code to the operator's smart phone (2) that maintains the application activated, wherein the application activation is interrupted when the vehicle's operator moves away more than a defined distance from the vehicle, where the defined distance is within a range of 20 to 100 meters.

For the purpose of the present invention, the second device (3) is a battery self-powered transmitter, wherein at least one second device (3) is attached to the cargo, wherein the second device (3) constantly transmits a signal to the first device (1), wherein the first (1) and second (3) device maintain a permanent virtual link, wherein the virtual link is interrupted when the second device (3) is a distance away from the first device (1) that exceeds the distance between the vehicle cargo compartment and the location of the first device (1), wherein the interruption of the virtual link between the first (1) and second (3) device indicates that the cargo is no longer in the vehicle, wherein the first device (1) constantly broadcast to the application in the vehicle operator's smart phone (3) the status of the virtual link between first (1) and second (3) devices.

For the purpose of the present invention the term vehicle refers to any vehicle capable of transporting cargo or shipments, wherein the term vehicle comprises but is not limited to a car, a truck, any vehicle with at least two wheels, a train, a water vessel, an airplane, etc.

For the purpose of the present invention the term dynamic data refers to data regarding events occurring constantly in real time.

Although this description presents preferred embodiments of the present invention, additional changes may be made in the form and disposition of the parts without deviating from the ideas and basic principles encompassed by the claims.

1. A system for monitoring a vehicle transported cargo comprising:
a. a first wireless communicating device placed in the vehicle transporting the cargo;
b. a smart phone with an application, wherein the smartphone is with the vehicle's operator, wherein the first device communicates wirelessly with the smart phone of the operator of the vehicle, wherein the first device activates an application in the smart phone, wherein the activated application in the smartphone generates dynamic data about the vehicle
c. at least one computer server, wherein the smart phone sends the dynamic data about the vehicle, by means of the internet of things, to the computer server.

2. The system of claim 1, further comprising a second wireless communicating device attached to the cargo, wherein the vehicle transports the cargo with the attached second communicating device; wherein the second device communicates wirelessly with the first communicating device; wherein the first and second communicating devices communicate permanently creating a constant virtual link as long as the cargo is being carried in the vehicle; wherein the first device communicates wirelessly with the smart phone of the operator of the vehicle activating the application in the smart phone, wherein the activated application in the smart phone generates dynamic data about the vehicle and about the constant virtual link between the first and second communicating devices; wherein the smart phone sends the dynamic data about the vehicle and about the constant virtual link, by means of the internet of things, to the computer server.
